(19) United States
(12) Patent Application Publication
(10) Pub. No.: US 2013/0322486 A1
(43) Pub. Date: Dec. 5, 2013

(54) APPARATUS AND METHOD FOR SUPPLYING HEAT TO A METAL MELT

(71) Applicant: Karl Venas, Haslum (NO)

(72) Inventor: Karl Venas, Haslum (NO)

(73) Assignee: ALU INNOVATION AS, Trondheim (NO)

(21) Appl. No.: 13/977,170

(22) PCT Filed: Dec. 22, 2011
(86) PCT No.: PCT/NO11/00353

§ 371 Date: Aug. 22, 2013

(30) Foreign Application Priority Data
Jan. 4, 2011 (NO) 20110005

(51) Int. Cl. F27D 27/00; F27B 3/08

(52) U.S. Cl. CPC F27D 27/00; F27B 3/085
USPC 373/86

(57) ABSTRACT

The invention relates to a device and a method for supplying heat to a metal melt, where in a closed container (11) with openings (13,14) for supply and discharge of the melt and where a sub pressure may be formed, a rotor (16) in the form of a hallow rotation body and a hollow driving shaft (20) containing the electrode (23) for supply of electric current for formation of an electric arc (34) towards the surface (31) of the metal of the melt. The lower end of the electrode (23) is positioned in a hollow head with an opening (35) downwards towards the bottom of the container (11). The hollow head is configured to provide access to the surface (31) of the metal melt, so that the electric arc (34) is formed inside the head and where the hollow driving shaft (20) possibly is configured for supply of gas to the metal melt. The lower end surface of the rotor (16) is configured so that a pumping effect in the heated melt beneath the lower end of the rotor (26) is formed, moving the heated melt sideways away from the rotor (16) along the lower, external end surface of the rotor (16).

### TECHNICAL FIELD OF THE INVENTION

The present invention relates to a method and a rotor for supplying heat to a metal melt where the rotor is arranged in a container with openings for supply and removal of the melt and where a sub-atmospheric pressure is established. The rotor comprises a hollow cylindrical body configured to rotate and a hollow driving shaft containing an electrode for supply of electrical current for establishing an electric arc towards the surface of the metal melt. The lower end of the electrode is arranged in a hollow head provided with an opening pointing in direction downwards towards the bottom of the container. The hollow head is designed for providing a contact area on a surface of the metal melt, so that the arc may be formed inside the head and where the hollow driving shaft is designed for supplying gas to the metal melt.

### BASIS FOR THE INVENTION

It is well known to use an electric arc between electrode(s) and a melt in order to supply heat to the melt. Large temperature differences and gradients between upper and lower layers in the melt may appear and large temperatures may easily appear locally in the equipment and/or the melt. Moreover, large temperature differences and temperature gradients between the upper and lower layers in the melt or between the melt in the vicinity of the arc and the surrounding melt. The chemical composition may also be affected in a detrimental way.

It has therefore been proposed to add heat to the melt by means of one or more rotors, where the wall of the rotor(s) is provided with opening extending through the wall, causing the melt to be sucked up through holes in the bottom of the rotor and together with gas, which optionally is added the heated melt, is pumped out and mixed with the surrounding melt through the openings in the rotor wall.

Such solution is known from the applicant's own publication WO 2004/076699, which hereby is included by the reference with respect to those features that is necessary for obtaining a heating of the melt in the desired manner.

WO 2004/076699 describes a plant for adding heat to a metal melt, comprising a container with a cover and with openings for supplying and discharging the melt and where a sub-atmospheric pressure may be formed. Moreover, the plant comprises a rotor in the form of a hollow, cylindrically shaped body connected to a hollow driving shaft, housing an electrode for supply of electrical power. The end of the electrode is positioned in a hollow head at the lower end of the cylindrically shaped body. The head is provided with an opening facing downwards towards the container bottom in order to cater for a surface of the metal melt inside the head. In such way an electric arc is formed between the end of the electrode and the metal surface inside the head. Moreover, several holes in the rotor wall are provided at the lower end of the rotor, so that the heated melt inside the head may be pumped out through the holes and is mixed with the melt surrounding the rotor.

WO 2009/120089 discloses a method for heating a liquid of non-conducting electricity, where a rotating body is provided with a cavity containing an electrode at the upper end of the cavity and an electrode at the lower end of the cavity, and wherein an electric arc is used for heating the liquid inside the cavity. At the lower end of the cavity the cavity is provided with opening in the cavity walls, arranged above the bottom of the cavity, in order to pump the heated liquid out of the cavity through the openings on the cavity wall.

In addition metal vapor is easily formed at the interface formed between the gas filled cavity and the surface of the liquid, struck by the electric arc.

For the prior art solutions used for heating of the melt by means of a rotor and an electric arc inside a rotor head, there is a need for as stable voltage in the electric arc as possible, and stable conditions at the surface of the melt inside the rotor head in addition to a good energy exchange are required.

### SUMMARY OF THE INVENTION

An object of the present invention is to provide a rotor solution contributing to a good energy transfer from the electric arc to the melt to be heated and at the same time creating as stable electric arc environment inside the rotor head as possible.

Another object of the invention is to provide an environment inside the rotor heat contributing to increase the effect of the electric arc so that a higher effect may be obtained for the same added current intensity or amperage, i.e. a larger drop in voltage of the electric arc, caused by a drop or reduction in the metal vapor concentration present inside the rotor head.

Another object of the rotor solution according to the invention is to provide a solution eliminating or at least reducing the possibilities for voltage variation in electric arc inside the rotor.

Another object of the invention is to provide a stable melting layer inside the rotor, so that formation of turbulence in the part of the melt being positioned inside the rotor is eliminated, or at least reduced.

Yet another object of the invention is to provide a rotor solution which eliminates, or at least reduces the possibilities for overheating the melt locally inside or around the rotor, such detrimental overheating producing metal vapor.

Yet another object of the invention resides in providing a rotor and a method for heating a melt, eliminating, or at least reducing the risk or possibilities of detrimental exposing the melt against, or introduction of detrimental gases, substances or chemical processes.

A still further object of the invention resides in improving existing heating processes of the melt.

The above objects are achieved with a solution which more closely is defined in the accompanying independent claims, while possible embodiments or variants are defined in the dependent patent claims.

According to an embodiment of the invention the lower end surface of the rotor is configured in such way that a pumping effect in the heated melt below the lower end of the rotor is formed in order to displace melt sideways away from the rotor along the lower, external end surface of the rotor. An important advantage of the pumping effect is that freed elements which evaporate because of the electric arc, are transported away with the gas supplied inside the rotor.

According to a variant of the invention, the lower, external end surface of the rotor is configured so that the area of said lower external end surface is increased by providing radial grooves, corrugations or ducts or the like, arranged on said external end surface and/or by arranging radial borings extending through the metal material of the constriction, thus providing ducts and openings for creating a pumping effect in the heated melt beneath the lower end of the rotor, moving the heated melt sideways away from the rotor along the lower, external end surface of the rotor along the grooves and through the holes or borings.

Said radial grooves, corrugations or ducts arranged at the lower external end surface of the rotor may preferably be inclined outwards and upwards away from the center of the rotor. Further, the cross section area of such grooves, corrugations or ducts may increase in a direction away from said rotor center.

The lower end of the rotor may therefore preferably be provided with an inwards projecting constriction reducing said lower end of the rotor, thereby increasing the lower end surface of the rotor. Further, said lower inwards projecting end surface may be configured to cause a sideways motion of the heated melt outside and below the rotor.

The lower end surface of the rotor may according to an embodiment may be provided with grooves, corrugations or the like, so that the melt is moved sideways away from the area beneath the rotor. Further, in connection with the lower end surface of the rotor the rotor may preferably, but not necessarily, be provided with borings extending through the material forming the constricted opening of the rotor, the axes of said openings preferably forming an angle with a plane being at a right angle with respect to the longitudinal axis of the rotor.

Moreover, the external side surface(s) of the rotor may at least at the lower end of the rotor possibly be provided with notches, slots, grooves, or profiles in order to enhance the pumping effect below the lower end surface of the rotor. Said notches, slots, grooves, or profiles may possibly extend in the longitudinal direction of the rotor and may be linear or helical. Alternatively, the notches, slots, grooves, or profiles may extend in a direction around the rotor on its external surface.

As discussed above the heated melt is brought to be moved beneath the rotor away from the space below the rotor along the external lower surface(s) of the rotor, by means the external shaping of the rotor.

For a solution according to the invention, a good energy exchange is secured as a consequence of stable conditions, without formation of turbulence in the melt and/or at the metal surface of the melt inside the rotor head. This provides a stable melt layer and enhanced transport of heated melt and gas away from the lower end of the rotor and an even and continuous supply of new melt to be heated up.

The solution according to the present invention contributes so that the metal vapor formed at the interface between the gas supplied to the inner cavity of the rotor and the part of the melt surface being in the region where the electric arc hits the melt, will effectively be transported away. This is achieved by configuring the lower end of the rotor in such way that a good pumping effect is provided just beneath the rotor, contributing so that i) the heated melt is transported along the constriction, radially outwards from the center of the rotor and up along the vertical external surface of the rotor, where the heated melt is mixed with the surrounding melt, and ii) that the metal vapor also is transported away in the same manner, thereby avoiding, or at least substantially reducing that such vapor is entering into the cavity of the rotor.

Since metal vapor is prevented from entering the rotor head, or to a very little degree is allowed to enter into the rotor head or cavity, an environment is maintained inside the rotor head or cavity with increased electric resistance, making it possible to increase the voltage for the same amperage or current intensity, whereby larger energy effects are transferred to the metal melt for heating. By improving the conditions inside the rotor head or cavity, smaller voltage fluctuations are achieved and an improved energy transfer and more effective use of the current is achieved.

### SHORT DESCRIPTION OF THE DRAWINGS

The present invention shall in the following be described in more details referring to the accompanying drawings, where:

FIG. 1a discloses a view seen from the side of a prior art plant for supplying heat to a metal melt, all in accordance with the prior art;

FIG. 1b shows schematically a view seen from below of the plant shown in FIG. 1a, where only the container, rotor, and direction of flow of the melt is shown;

FIG. 2a shows schematically a vertical section through an embodiment of the lower end of the rotor according to the present invention;

FIG. 2b shows schematically a horizontal view seen from below of the embodiment shown in FIG. 2a;

FIG. 3 shows schematically a vertical section through a second embodiment of the lower part of a rotor according to the present invention,

FIG. 4 shows a horizontal section through the lower part of a third embodiment of the rotor, provided with vertical recesses or outwards protruding fins, but not showing the constraint at the end of the rotor head, and

FIG. 5 shows schematically an end view seen from below of the rotor shown in FIG. 3.

### DETAILED DESCRIPTION OF THE INVENTION

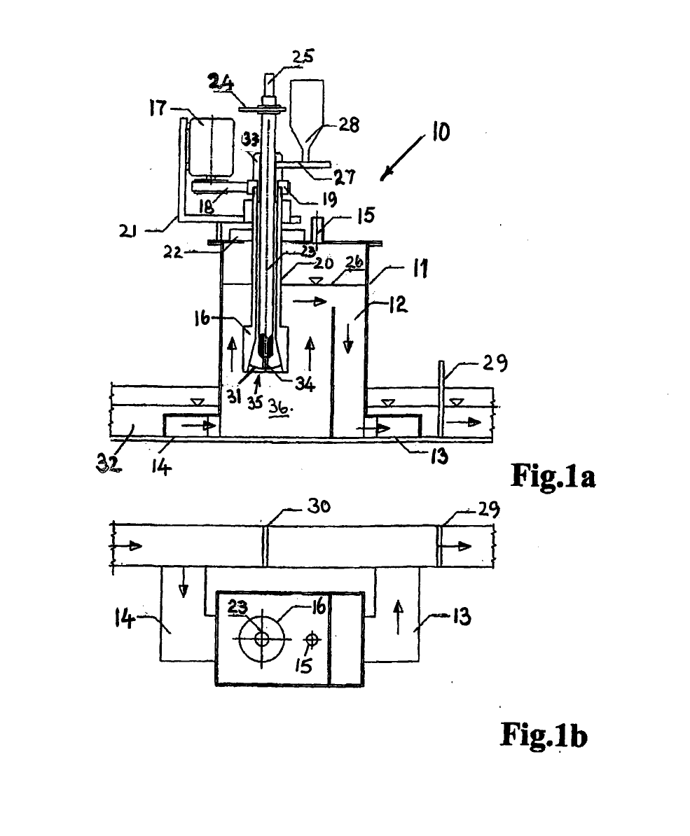

FIG. 1 shows a principle view according to the prior art of a plant 10 for supply of heat to a metal melt. The plant 10 comprises a cylindrical or rectangular, vertical container 11 with a discharge exit inside the container in the form of a discharge duct 12. The melt to be treated, flows out through the opening 13 at lower end of the discharge duct 12. The melt to be treated flows into an opening 14 at the lower end of the container 11 and is lifted upwards due to a sub-atmospheric pressure in the container 11. The sub-atmospheric pressure is produced by means of a vacuum pump (not shown) connected to a hose connecting pipe 15. In the container 11 a rotor 16 is arranged, driven by means of a motor via a belt drive 18 or similar, to a pulley 9 which is mounted onto a tubular shaft 10, and connected to the rotor 10. The rotor 16 is hollow and at its lower end, the rotor 16 is provided with an opening 35 in free communication with the surrounding melt. The shaft 20 is connected to the motor 17. The motor 17 is mounted on a bracket 11. The bracket 21 may be fixed to the container or to a separate structure. A sealing between the rotor shaft 20 and the container 11 may be in the form of a sealing means 22. On the bracket 21 a bearing for the rotor shaft 20 is arranged. An electrode 23 is centrally arranged in the shaft. The upper end of the electrode 23 is connected to a current supplying connection (not shown) via a connector 14. A centrally arranged hole for supply of gas is drilled through the electrode 23. The hole is connected to a pipe end 25 fixed to the end of the electrode 23. The gas to be supplied through the electrode 23 is preferably argon or nitrogen or a mixture thereof. Other gases may, however, be used. The gas above the upper melt level 26 will consists of a mixture of gas supplied to the rotor and gases which possibly may be released from the melt. Gases may be discharged through the pipe 15. A ring 23, serving as both as a seal and electrical insulation is arranged between the rotor shaft 20 and the electrode 23. The ring 33 is provided with a conduit for discharging both gases and particles through the pipe end 27, which may be connected to a powder dispenser 28. A chute, in which is arranged a gate valve 19 and a gate valve 20 is connected to the equipment. Several holes (not shown) leading from the periphery towards the melt surface 31 is arranged at the lower end of the rotor. The level 31 of the melt is determined by the gas pressure inside the rotor 16.

At start-up the gate valve 29 is closed and the gate valve 30 is open. A duct 32 is filled up to a certain level. The melt will now fill up part of the space inside the inner cavity of the rotor 16. When vacuum is applied from the vacuum pump via the connector 15, and gas is at the same time supplied through the electrode 23 and/or through the ring 33 to the inner cavity of the rotor 16, the metal will be sucked up to the upper level 26. The rotor 16 starts rotating, and a voltage from a rectifier or a transformer (not shown) is applied. The current is connected by means of the cable contact 24 to the electrode 23, and to a contact connected to the melt or via the shaft 20 of the rotor by means of a sliding contact (not shown). An electric arc 33 is formed between the electrode 23 down towards the metal surface 31. Rotation of the rotor 16 causes the heated melt inside the rotor 16 to be pumped out through the holes (nor shown) in the wall of the rotor 16 and to be mixed with the melt in the container 11. The holes in the rotor wall may be round or polygonal and may be evenly positioned around the periphery of the rotor 16.

When the melt has reached the desired temperature, the gate valve 29 is opened while the gate valve 30 is closed. The metal will flow out of the container 11 for further treatment.

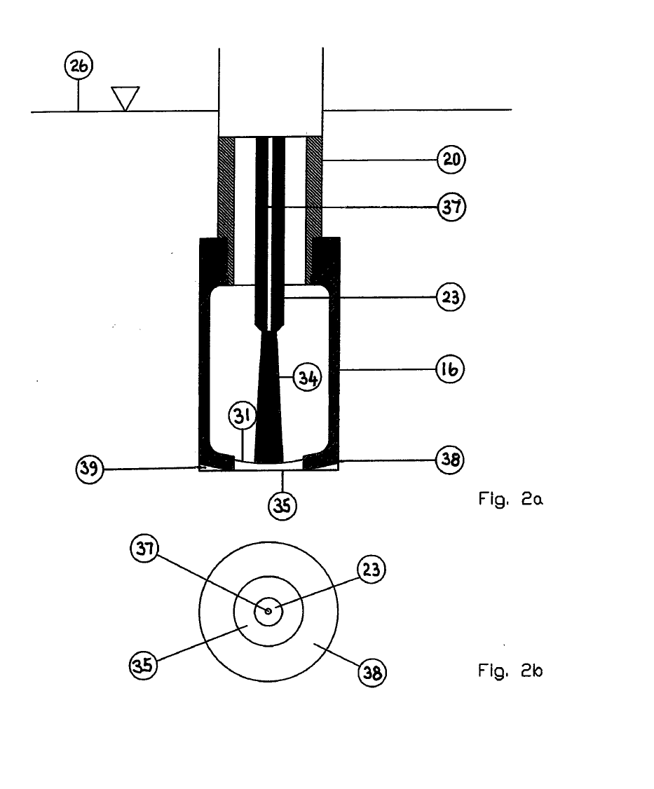

The invention shall in the following be described in more detail by means of embodiments, shown in FIG. 2-5. Generally, a plant where the invention is incorporated corresponds in principles the plant described in conjunction with the FIGS. 1a and 1b, the only major difference being the configuration of the rotor 16 and its lower end. In order to describe the invention, reference is in general made to FIGS. 1a and 1b, using the same reference numbers where appropriate.

The present invention relates generally to heating of an electrically conducting melt by means of an electric arc between one or more fixed electrodes and the melt, i.e. so that the melt may be the other electrode of the system. This means that a contact point for an electrical conductor (not shown) is associated with the melt in order to enable current to flow through the melt.

FIG. 2a shows schematically a vertical section through one embodiment of the lower end of the rotor 16 according to the invention, while FIG. 2b shows schematically a horizontal view seen from below of the embodiment shown in FIG. 2a. The Figures do not show the part of the plant 10 which corresponds to the prior art plant, shown i FIGS. 1a and 1b.

A rotor 16 is positioned below the melt surface 26 inside a container 11, which, where not explicit or implicit expressed otherwise, corresponds to the container 11 in the plant 10 shown in FIGS. 1a and 1b. In the rotor 16 a centrally arranged electricity conducting electrode 23 is arranged, for formation of an electric arc 34 against a metal surface 31 at the lower end of the rotor 16, for example arranged slightly above the opening 35 at the lower end of the electrode 16. Gas may be supplied to the rotor through a centrally arranged opening 37 in the electrode 23 and/or between the tube shaped shaft 20. Gas is fed out to the melt through the opening 35 at the lower end of the rotor 16. At its lower end, the rotor 16 is provided with a termination or end surface 38 projecting inwards towards the centrally arranged opening 35, so that the rotor 16 at this lower end is provided with a lower constricting surface forming an inner bottom surface in the rotor head and an external end surface with a smaller surface area than the inner cross sectional area of the rotor 16. Further, it should be noted that the inner surface area of this constricted surface 38 may have a concave or an arced shape which changes continuously over into the vertical, cylindrical shape of the rotor 16.

The electrode 11 may be regulated vertically up or down. Current, which may be direct or alternating current, is delivered to the electrode 11 and the tube shaped shaft 20 or to the metal melt, which is electric conducting, corresponding to the description of FIGS. 1a and 1b. When the inner cavity of the container is subjected to a vacuum and when pressure is supplied to the inner cavity of the rotor 16, while the rotor starts rotating, the melt will gradually be pressed out of the inner cavity of the rotor 16. When the lower free end of the electrode 23 is clear of the inner metal surface 31 at the lower end of the rotor 16, current is applied and an electric arc 34 is established for heating the melt. As a consequence of the rotation and partly due to the super pressure applied inside the cavity of the rotor 16 an internal, continuous rotational parabolic melt body will be formed inside the rotor with a curved surface on the lower constriction 38, and further up along at least the lower part of the internal vertical wall of the rotor 16. For this reason and in the absence of vertical openings through the vertical side wall of the rotor 16 a stable melt layer is this formed inside the rotor without any tendency of formation of internal turbulence inside the rotor 16. In such way good energy exchange and reduced risk for large, detrimental voltage variations over the electric arc 34 is achieved.

According to this solution the heated melt will automatically be transported from the center at the lower side of the rotor 16, radially outwards due to the rotation and the increased peripheral speed of the rotation. Heated melt positioned below the opening 35 will thus be pulled upwards, heated due to the effect of the electric arc 34 and brought to move sideways away beneath the rotor. In order to contribute to this pumping effect and pumping movement to the melt, the lower, external bottom surface of the lower constriction 38 may be provided with radial grooves 39 or the like in order to improve the transport of the heated melt. The grooves 39 may also increase the turbulence in the melt below the rotor, but not to any degree the conditions inside the rotor 16 head.

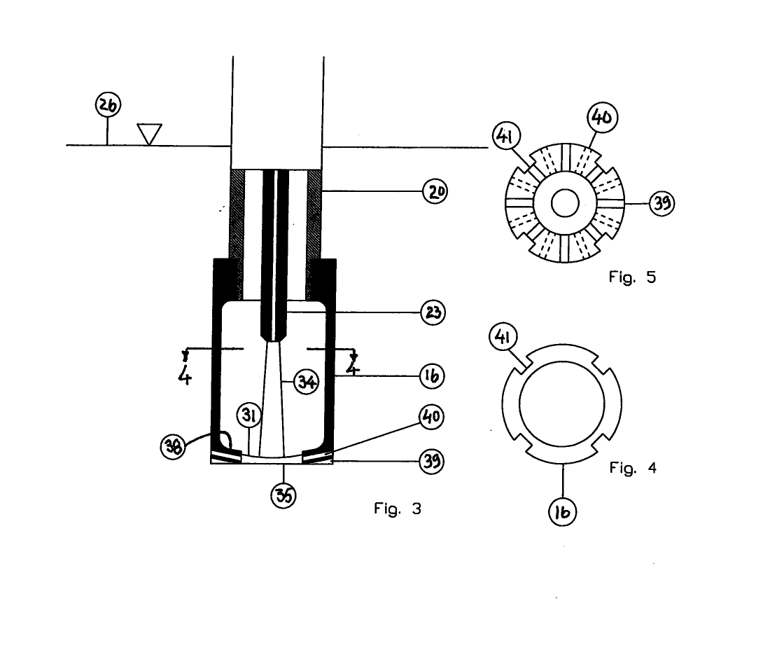

FIG. 3 shows schematically a vertical section through another embodiment of the lower part of the rotor 16 according to the invention. In order to increase the external, outwards directed motion of the melt below the lower surface of the rotor the radial grooves 39 may, in addition or instead, be provided with radial openings 40 in and extending through the material forming the lower constriction 38. The openings 40 may preferably, but not necessarily, be cylindrical and extend radially outwards and upwards towards the external periphery of the rotor 16.

In order to increase the pump effect of the melt below the rotor 16 further, the vertical surface of the rotor 16 may be provided with vertical straight or helical grooves. Such embodiment is shown in FIG. 4, showing a horizontal section through the lower part of a third embodiment of the rotor, seen along the line 4-4 in FIG. 3. Alternatively, or in addition, outwards projecting fins or the like may be arranged on the cylindrical surface of the rotor. It should be appreciated that in FIG. 4, the centrally arranged bottom opening of the rotor head is shown.

The electrode 23 may be regulated vertically, up and down. The current, which may be direct or alternating current, is connected to the electrode 23 and the shaft 20 or to the metal melt which is conducting electricity. According to the invention the heated melt is automatically transported from the center of the bottom radially outwards due to the increasing peripheral velocity.

FIG. 5 shows schematically an end view of the external bottom surface of the rotor head, showing the centrally arranged electrode 23, the bottom opening 35 at the lower end of the rotor head, the constriction 38, the vertical notches or the like 41 and the grooves 139 and the openings 40.

1. Apparatus for supplying heat to a metal melt of a type conducting electricity, where in a closed container (11) with openings (13,14) for supply and discharge of melt and wherein a sub-pressure may be formed, a rotor (16) in the form of a hollow rotational body and a hollow driving shaft (20) containing an electrode (23) for supply of electric current for formation of an electric arc (34) towards the lower end of the rotor (16), the lower end of the rotor (16) being provided with an opening (235) towards the surrounding melt, and that the hollow rotational body is configured to provide access to the surface (31) of the melt so that the electric arc is formed inside the hollow rotational body, the rotor (16) being at its lower end provided with an inwards projecting directed constriction (38) reducing the lower opening (35) of the rotor (16),
characterized in that the lower end surface of the rotor (16) is increased by arranging radially extending slots, grooves (39), corrugations or channels arranged on the lower end surface and/or by arranging radially extending borings through the construction (38), so that a pumping effect in the heated melt beneath the lower end of the rotor (26) is created, moving the heated melt sideways away from the rotor (16) along the lower external end surface of the rotor (16).

2. Apparatus according to claim 1, where the axes of said borings (40) form an angle with a plane being perpendicular to the longitudinal axis of the rotor (16).

3. Apparatus according to claim 1, where the external vertical surface of the rotor (16) at least in the region of the lower end of the rotor (16) is provided with slots (41), grooves or profiles in order to improve the pumping effect beneath the lower end surface of the rotor (16).

4. Apparatus according to claim 3, wherein the slots (41), grooves or profiles extend in the longitudinal direction of the rotor (16) and may be straight or helical.

5. Apparatus according to claim 4, where the slots (41), the grooves or the profiles extend in a direction around the rotor on its external surface.

6. Apparatus according to claim 5, wherein the hollow shaft (20) is configured to supply gas of the metal melt.

7-8. (canceled)

9. Method for heating a melt, where a rotor (16) is used, having an electrode (23) incorporated, the lower end of the electrode (23) being terminated in a closed cavity in the rotor (16) with an downward open opening (35) towards the melt, and where an electric arc (34) is formed between the end of the electrode (23) and a metal surface (31) inside the closed cavity for heating the melt in the region below the rotor (16),
characterized in that the heated melt beneath the rotor (16) is brought to be moved away from the region (16) below the external lower surface(s) of the rotor (16) by means of the external shape of the rotor (16).
